(19) United States
(12) Patent Application Publication
(10) Pub. No.: US 2010/0186773 A1
(43) Pub. Date: Jul. 29, 2010

(54) CLEANING DEVICE AND GRAFFITI REMOVAL

(75) Inventor: Thomas Jemt, Vallingby (SE)

Correspondence Address: BUCHANAN, INGERSOLL & ROONEY PC, POST OFFICE BOX 1404, ALEXANDRIA, VA, 22313-1404, US

(73) Assignee: Nordic Ground Support Equipment IP AB, Stockholm (SE)

(21) Appl. No.: 12/666,281

(22) PCT Filed: Jun. 5, 2008
(86) PCT No.: PCT/SE08/50667

§ 371 Date: Jan. 27, 2010

(30) Foreign Application Priority Data
Jun. 27, 2007 (SE) 0701568-8

(51) Int. Cl. B08B 3/00

(52) U.S. Cl. 134/21; 134/99.1

(57) ABSTRACT

A cleaning device is provided for cleaning a surface comprising a base unit having a rotating brush. The cleaning device is efficient, economic and environment friendly through recuperative use of a cleaning agent.

### FIELD OF THE INVENTION

The present invention relates to a cleaning device for cleaning surfaces. The invention further relates to the use of such a cleaning device for graffiti removal, and to a method for removing graffiti.

### BACKGROUND OF THE INVENTION

Graffiti, tags and other forms of scrawl and scribble, in this document collectively termed graffiti, are a common problem particularly in urban areas. Apart from the aesthetic aspects of having visible surfaces damaged by graffiti, many people also feel uncomfortable or unsafe in areas where there is graffiti, or when otherwise encountering it. Prompt removal of graffiti not only restores the surface, but also discourages “artists” from doing graffiti, as having their “art” on display is a strong driving force for doing it in the first place.

As an example, the graffiti policy of a large Swedish railway company states that graffiti on a railway carriage should be removed within three hours, or the carriage is taken out of traffic. Needless to say, graffiti removal costs Swedish railway and train operators hundreds of millions of SEK every year comprising both direct costs related to the removal service itself, and indirect costs related to the idle carriages caused by the inefficiency of traditional graffiti removal methods.

Graffiti removal traditionally comprises the following steps:

1) Spraying of a cleaning agent, typically a diluted solvent, onto the surface to be cleaned.

2) Waiting for the solvent to dissolve the graffiti, and optionally brushing or rubbing the solvent onto the surface to improve the cleaning effect.

3) High-pressure washing with hot water.

Both the cleaning agent and the paint residues pose a threat to the environment as well as to the operator performing the graffiti removal, in particular as the heat of the water increases the evaporation and fume formation of the cleaning agent, and as the cleaning agent/hot water mixture together with the removed paint is normally not collected but left in the environment. This is also a reason why very highly diluted cleaning agents are normally used, which results in a poor over-all cleaning effect. The cleaning agent is typically highly specialized for the purpose, and therefore expensive.

The high-pressure water jet required to remove the graffiti may also severely damage the surface to be cleaned; this is particularly true when the hot water is combined with an abrasive substance, creating a sand-blasting effect. Such substances are often employed to remove particularly difficult graffiti. Further, a high-pressure jet applied to the contaminated surface may even push the graffiti deeper into the surface, and thus work against its own purpose.

Moreover, a traditional graffiti removal equipment is large, complicated, heavy, and consumes lots of cleaning agent, water and energy for heating and pressurizing. It is therefore often mounted in a truck that has been customized for the purpose.

### SUMMARY OF THE INVENTION

It is an object of the present invention to solve, or at least mitigate, parts or all of the above mentioned problems. To this end, there is provided a cleaning device adapted for cleaning a surface, wherein the cleaning device comprises a base unit and a hand unit. The base unit comprises a tank adapted for containing a cleaning agent, e.g. a solvent for graffiti.

The cleaning device further comprises first means for pumping a first flow of cleaning agent from the tank to the hand unit via a first hose, and second means for pumping a second flow of a mixture of air, cleaning agent, and contaminant from the hand unit to the base unit via a second hose Preferably, the first hose is located inside the second hose, as it makes the device easier to operate. By pumping back the mixture to the base unit, the cleaning device automatically collects the used cleaning agent, which makes it possible to dispose of it properly or to reuse it over and over again.

The hand unit comprises a body, which preferably is provided with means adapted for holding the hand unit. Preferably, the holding means is adapted for holding the hand unit with two hands, and even more preferably it is shaped as an airplane yoke as it offers the operator a particularly ergonomic working posture. Connected to the body is a sealing ring having a limited air permeability, the sealing ring being configured for forming a cleaning chamber defined by the surface to be cleaned, the sealing ring, and the body. In this disclosure, the term “sealing ring” refers to any seal that defines a closed, or almost closed, curve. The term “ring” is therefore not limited to circular rings; a ring in line with the definition of this disclosure may be oval, triangular, rectangular, or have any other shape. The sealing ring is arranged to be in contact with the surface to be cleaned along a closed, or essentially closed, curve, and to form a sealing chamber together with the hand unit body and the surface to be cleaned.

It is important that the sealing ring have a limited air permeability in order to maintain an under-pressure inside the cleaning chamber, thus minimizing cleaning agent leakage to the ambient, while at the same time allowing some amount of air to enter the cleaning chamber and form said second flow together with the cleaning agent and the contaminants. Preferably, the sealing ring is an outer perimetric brush having substantially parallel bristles. The use of a brush allows a suitable limited level of air flow through the sealing ring. More preferably, the bristles of the outer brush have a length of between 40 and 70 mm, as it offers a good sealing against both a flat surface and a typical railroad carriage having an outer shell of corrugated sheet steel with a profile depth of approx. 30 mm.

The hand unit further comprises a scrubbing device arranged on the body inside the sealing ring, said scrubbing device being adapted for scrubbing the surface to be cleaned. Preferably, the scrubbing device is an inner brush having bristles configured for being in contact with and brushing the surface to be cleaned.

Preferably, the scrubbing device is adapted for rotating about an axis substantially perpendicular to the surface to be cleaned. More preferably, the scrubbing device is circular, as this configuration is not prone to vibrations when cleaning non-flat surfaces.

Further, the hand unit comprises a motor for driving the scrubbing device; preferably an electric motor. This enables the inner brush to rotate with substantially maintained speed when in contact with the surface to be cleaned.

The hand unit is further provided with an inlet for connecting the cleaning chamber to the inside of the first hose; the inlet thus serves for allowing said first flow of cleaning agent from the base unit to the cleaning chamber. Similarly, the hand unit is provided with an outlet for connecting the cleaning chamber to the inside of the second hose, which allows said second flow of a mixture of air, cleaning agent and contaminant to be sucked back to the base unit. To increase the safety of the operator and other people, the hand unit preferably comprises means for controlling said first flow of cleaning agent in said first hose. Preferably, it also comprises means for controlling said second flow of a mixture of air, cleaning agent, and contaminant in said second hose, and means for controlling the motion of the scrubbing device. In this manner, the most important functions of the cleaning device can be controlled from the hand unit. Preferably, the base unit comprises means for separating cleaning agent from said mixture and for transferring the separated cleaning agent into the tank. Using this configuration, the number of times the cleaning agent may be re-used is significantly increased.

Preferably the cleaning agent is a solvent; and more preferably, it comprises 2-(2-butoxyethoxy)ethanol, dipropylene glycol methyl ether, and branched ethoxylated tridecylalcohol, as these agents have proven to efficiently dissolve graffiti.

Thanks to the recuperative operation of the cleaning device, a more highly concentrated cleaning agent than those employed in conventional cleaning methods may be used, permitting cleaning at a lower temperature with maintained or improved efficiency. The cleaning device is therefore preferably configured for performing cleaning with a cleaning agent that is at ambient temperature, as this minimizes leakage of evaporated cleaning agent fumes from the entire cleaning device. Keeping the cleaning agent at ambient temperature also allows for a simpler cleaning device than conventional systems, and for lower power consumption. Moreover, using a more highly concentrated cleaning agent allows for cleaning a surface without exposing it to high pressure. Therefore, the cleaning device is configured to operate at a working pressure of the cleaning agent of below 20 bar, in order to minimize wear and damage to the surface and to avoid pressing the contaminant further into the surface if it is porous.

According to another aspect of the invention, a cleaning device of the type disclosed above is used for graffiti removal.

According to yet another aspect of the invention, there is provided a method for removing graffiti from a surface to be cleaned, the method comprising

spraying a cleaning agent onto the surface to be cleaned;

scrubbing the surface to be cleaned; and

sucking a mixture of air, cleaning agent and contaminant from the surface to be cleaned.

Preferably, the method comprises separating cleaning agent from said mixture. More preferably, the method comprises performing repeated cleaning using the separated cleaning agent.

Preferably, the spraying, scrubbing, and sucking takes place in a cleaning chamber that is defined by a sealing ring, a hand unit body, and the surface to be cleaned.

Using the present invention may not only save cleaning agent, environment and operator health, but graffiti removal may be performed at a speed of as high as 6 m²/minute. The separation of the device into a base unit and a cleaning agent collecting hand unit facilitates cleaning of vertical surfaces. Further, the equipment can be made significantly smaller than existing graffiti removal equipment, which saves the expense of mounting it on a customized truck. Even further, the present invention offers the possibility of recycling the cleaning agent or recirculating it over a longer period of time, minimizing pollution, graffiti removal cost, and human exposure to toxic substances.

### BRIEF DESCRIPTION OF THE DRAWINGS

FIG. 1 is a diagrammatic illustration of an example of a cleaning device according to the invention.

FIG. 2A is a diagrammatic top view of an example of a hand unit, as seen from an operator.

FIG. 2B is a diagrammatic view of the same hand unit, as seen from the surface to be cleaned.

FIG. 2C is a diagrammatic side view of the same hand unit.

### DETAILED DESCRIPTION OF THE EXEMPLARY EMBODIMENTS

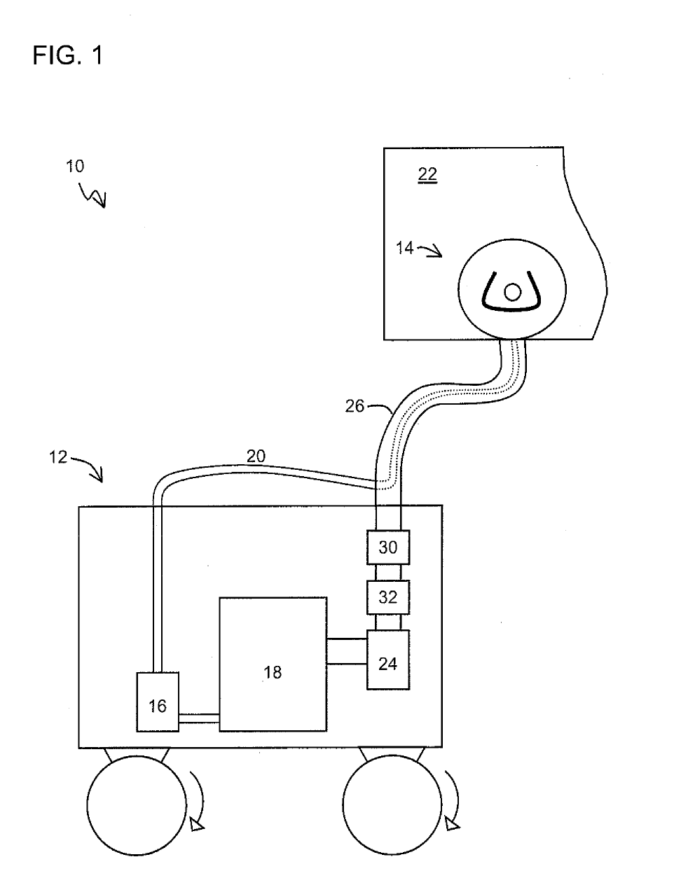

FIG. 1A shows a cleaning device 10, comprising a base unit 12 and a hand unit 14. An electrically powered pump 16 connected to the base unit 12 is adapted for pumping a cleaning agent from a tank 18, via a first hose 20, to the hand unit 14, which is adapted for removing graffiti from a surface 22 using the cleaning agent.

A second electrically powered pump 24, connected to a second hose 26, is adapted to create an airflow from the hand unit 14 to the base unit 12, and thus suck back the cleaning agent together with graffiti paint residues and other contaminants from the surface 22 to the base unit 12. The second hose 26 is connected to the tank 18 via a coarse filter 30 and a fine filter 32 adapted for removing larger and finer contaminant particles, respectively, from the cleaning agent, and via the second pump 24.

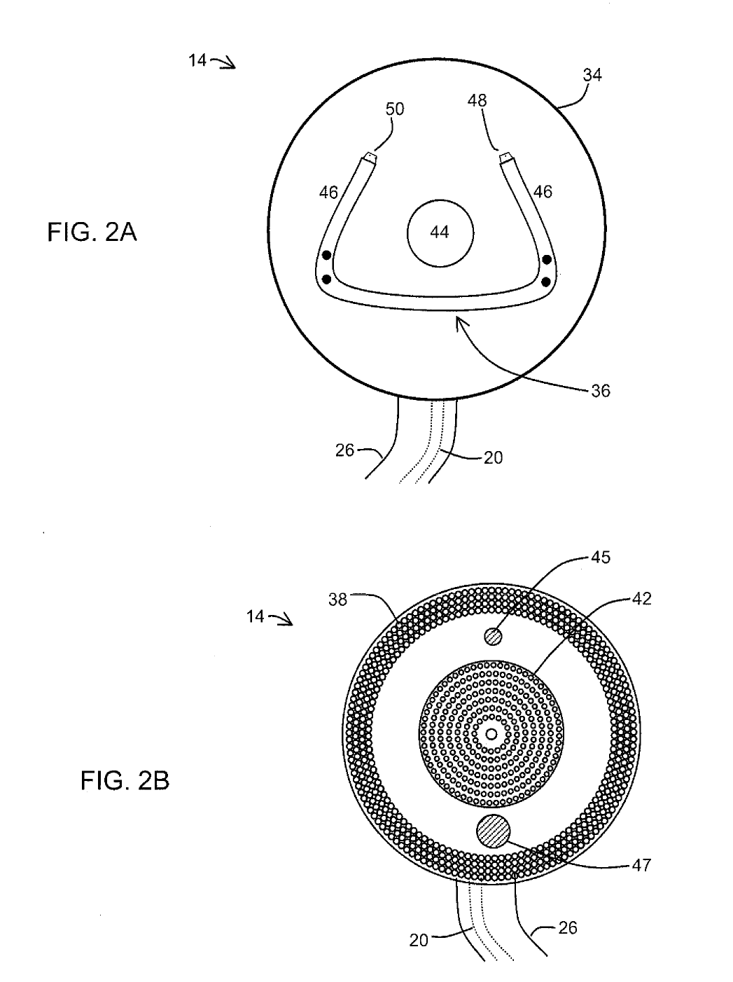

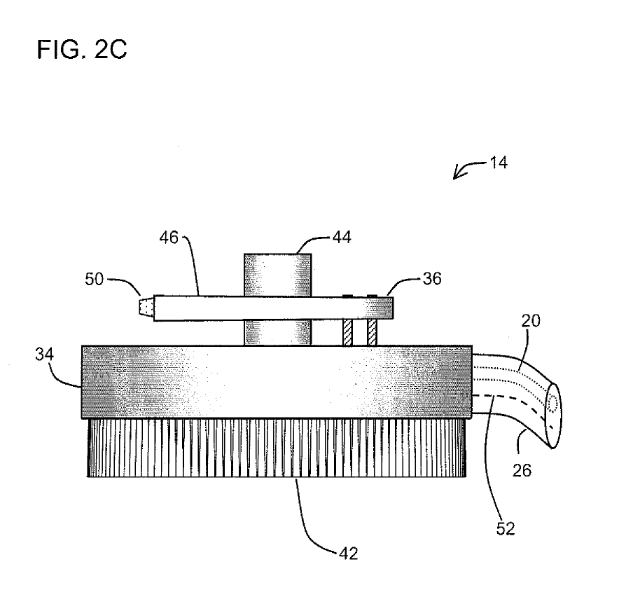

FIGS. 2A-2B illustrate a hand unit 14, comprising a body 34 and means 36 for holding the hand unit, in this example having the U-shape of an airplane yoke. Further, the hand unit 14 comprises an outer, annular, substantially tight brush 38, which forms a cleaning chamber together with the body 34 and the surface 22 to be cleaned. The length of the bristles of the brush 38 is adapted to the structure of the surface 22 to be cleaned; in this example, the bristles are about 50 mm long for the purpose of tightening against the corrugated sheet steel shell of a railway carriage.

Inside the cleaning chamber, a circular disc-shaped inner brush 42 is disposed and configured for brushing the surface 22. Brush 42 is connected to an electric motor 44, which is configured to rotate the brush 42 around an axis substantially perpendicular to the surface 22. The bristles of both brushes 38, 42 can be made of e.g. nylon, or any other suitable material that is resistant to the cleaning agent in use.

Openings in the cleaning chamber, in this example embodied as an inlet 45 and an outlet 47 located in the body 34, allow flow of cleaning agent to/from the cleaning chamber. Inlet 45 is connected to the base unit 12 via the first hose 20, and outlet 47 is connected to the base unit 12 via the second hose 26. The hand unit is not limited to having only one inlet and one outlet, but it is important that the inlets are not located adjacently to the outlets in order for the cleaning agent to pass through the cleaning chamber. In the embodiment shown, inlet 45 and outlet 47 are located on opposite sides of the inner brush 42.

At the thumb location of each of the hand grips 46 of the yoke 36 there is a button. A first button 48 serves for activating the first pump 16 and the brush motor 44; depressing button 48 puts the first pump 16 and the brush motor 44 in motion; releasing it stops them. A second button 50 is a switch that serves for starting and stopping the second pump 24. Pressing it once starts the second pump 24; pressing it again stops the same pump.

The hand unit 14 is connected to the base unit 12 via the first and second hoses 20, 26, and via electrical cables 52, which transmit electrical power from the base unit 12 to the hand unit 14 and pump control signals from the hand unit 14 to the base unit 12. For increased ease of handling and improved manoeuvrability of the entire device 10, the first hose 20 as well as the electrical cables 52 are located inside the second hose 26, which has a substantially larger diameter than the first hose 20.

The hand unit 14 is not limited to having one single inner brush; improved cleaning performance and/or ergonomics may be achieved by using e.g. two or more brushes rotating in opposite directions, and/or having differently oriented axes of rotation. Also other types of scrubbing devices may be used. Neither is an electric motor the only conceivable means of rotating the inner brush. Other methods can be used; a rotary motion may for example be obtained by locating a cleaning agent spray nozzle on the inner brush and orienting the nozzle in a non-radial direction relative to the axis of rotation of the inner brush. An electric motor or a similarly powerful device, e.g. a pneumatic or hydraulic motor, is however preferred, as it enables the operator to push the hand unit with a relatively strong force against the surface to be cleaned with maintained rotary speed of the inner brush, thus achieving high cleaning efficiency.

Further, the outer brush is not limited to being annular and having bristles with uniform length. Also other shapes, e.g. oval or rectangular, are suitable, and a varying bristle length along the perimeter of the outer brush may be suitable for particular surfaces. Further, other types of seals may be used instead of or in combination with a brush, such as a rubber lip, a sponge strip, a felt strip, narrow overlapping strips or scales of rubber forming a labyrinth seal, etc, or any combination thereof.

The same applies to the inner brush; it need not be circular, but may have any shape. Also other types of scrubbing devices may be used instead of, or in combination with the brush for scrubbing the surface to be cleaned. Examples of these other types of scrubbing devices are sponges, rags, mops, scouring pads, abrasive pads etc, or any combination thereof. Also these other types of scrubbing devices are covered by the appended claims.

Further, the verb “scrubbing” is intended to comprise scrubbing, rubbing, polishing, and/or brushing the surface using a scrubbing device.

Even though the scrubbing device described in detail above with reference to the figures is arranged to rotate about an axis that is perpendicular to the surface 22, it may also be configured to rotate around an axis that is non-perpendicular to the surface 22. In fact, the axis of rotation may deviate with up to 10 degrees with maintained or even improved efficiency. Also other types of motion patterns, other than a rotary motion of the scrubbing device, may be used and are covered by the claims. By way of example, the scrubbing device may be arranged to perform an oscillatory motion back and forth, or to perform a random vibratory motion. It may also be arranged to rotate about an axis that is, e.g., parallel to the surface 22.

It is obvious to those skilled in the art that the cleaning agent may contain residues of the contaminant, and still be viable as a cleaning agent. Therefore, the separation of the cleaning agent from the mixture of air, cleaning agent and contaminant is optional, and need not be perfect. A skilled person may find many ways to practice the invention; the detailed description above is provided as an example only, and should not in any way be understood to limit the scope of the invention as defined in the appended claims.

1. Cleaning device adapted for cleaning a surface, said cleaning device comprising
a base unit, comprising a tank adapted for containing a cleaning agent; said cleaning device further comprising
a hand unit;
first means for pumping a first flow of cleaning agent from the tank to the hand unit via a first hose; and
second means for pumping a second flow of a mixture of air, cleaning agent, and contaminant from the hand unit to the base unit via a second hose;
said hand unit comprising
a body;
a sealing ring having a limited air permeability, the sealing ring being configured for forming a cleaning chamber defined by the surface to be cleaned, the sealing ring, and the body;
a scrubbing device arranged on the body inside the sealing ring, said scrubbing device being adapted for scrubbing the surface to be cleaned;
a motor for driving the scrubbing device;
an inlet for connecting the cleaning chamber to the inside of the first hose; and
an outlet for connecting the cleaning chamber to the inside of the second hose.

2. The cleaning device according to claim 1, wherein the base unit further comprises means for separating cleaning agent from said mixture and for transferring the separated cleaning agent into the tank;

3. The cleaning device according to claim 1, wherein the hand unit comprises means provided on the body and adapted for holding the hand unit with two hands.

4. The cleaning device according to claim 1, wherein the sealing ring is an outer perimetric brush having substantially parallel bristles.

5. The cleaning device according to claim 1, wherein the scrubbing device is an inner brush having bristles configured for brushing the surface to be cleaned.

6. The cleaning device according to claim 1, wherein the scrubbing device is adapted for rotating about an axis substantially perpendicular to the surface to be cleaned.

7. The cleaning device according to claim 1, wherein said first and second means for pumping said first and second flows are comprised in the base unit.

8. The cleaning device according to claim 1, wherein the cleaning device is configured to perform cleaning using a cleaning agent that is substantially at ambient temperature.

9. The cleaning device according to claim 1, wherein the cleaning device is configured to only operate at a working pressure of the cleaning agent of below 20 bar.

10. The cleaning device according to claim 4, wherein the length of the bristles of the outer brush is in the range 40 mm to 70 mm.

11. The cleaning device according to claim 1, wherein the first hose partly or completely is located inside the second hose.

12. The cleaning device according to claim 1, wherein the hand unit comprises means for controlling said first flow of cleaning agent in said first hose;

13. The cleaning device according to claim 1, wherein the hand unit comprises means for controlling said second flow of a mixture of air, cleaning agent, and contaminant in said second hose, and means for controlling the motion of the scrubbing device.

14. The cleaning device according to claim 1, wherein the cleaning agent comprises 2-(2-butoxyethoxy)ethanol, dipropylene glycol methyl ether, and branched ethoxylated tridecylalcohol.

15. The cleaning device according to claim 1, wherein the scrubbing device is configured to be driven by means of an electric motor.

16. (canceled)

17. A method for graffiti removal from a surface to be cleaned comprising utilizing the cleaning device of claim 1.

18. A method for removing graffiti from a surface to be cleaned, the method comprising:
spraying a cleaning agent onto the surface to be cleaned; and
sucking a mixture of air, cleaning agent and contaminant from the surface to be cleaned, the method being characterized in
scrubbing the surface to be cleaned, wherein at least the scrubbing is performed in a cleaning chamber.

19. The method according to claim 18, further comprising the step of separating cleaning agent from said mixture.

20. The method according to claim 19, wherein, after separating cleaning agent from said mixture, said method is again performed using the separated cleaning agent.

21. The method of claim 18, wherein the spraying, scrubbing, and sucking steps are performed in said cleaning chamber, and wherein the cleaning chamber is defined by a sealing ring, a hand unit body, and the surface to be cleaned.
